(19) United States
(12) Patent Application Publication
(10) Pub. No.: US 2024/0112832 A1
(43) Pub. Date: Apr. 4, 2024

(54) Dynamic Submarine Power Cable With Corrugated And Smooth Metallic Water Barrier

(71) Applicant: NKT HV Cables AB, Lyckeby (SE)

(72) Inventors: Andreas Tyrberg, Lyckeby (SE); Erik Eriksson, Växjö (SE)

(21) Appl. No.: 18/473,452

(22) Filed: Sep. 25, 2023

(30) Foreign Application Priority Data
Oct. 4, 2022 (EP) 22199612.7

(51) Int. Cl. H01B 7/282; H01B 7/14; H01B 13/22

(52) U.S. Cl. CPC H01B 7/2825; H01B 7/14; H01B 13/22

(57) ABSTRACT

A dynamic submarine power cable having: a conductor, an insulation system arranged around the conductor, wherein the insulation system includes an inner semiconducting layer arranged around the conductor, an insulation layer arranged around the inner semiconducting layer, and an outer semiconducting layer arranged around the insulation layer, and a metallic water blocking layer arranged around the insulation system, wherein the metallic water blocking layer is formed by a first section that is a corrugated metallic water blocking layer and a second section that is a smooth metallic water blocking layer.

### TECHNICAL FIELD

The present disclosure generally relates to dynamic submarine power cables.

### BACKGROUND

Dynamic submarine power cables are subjected to movements when suspended from a floating structure to the seabed. Therefore, such cables typically have a corrugated metallic water barrier to provide better fatigue properties to the metallic water barrier. An example of such a solution is disclosed in EP2896053.

Dynamic submarine power cables are nowadays considered for use in deep-water installations, e.g., for water depths of more than 1500 m or more than 2000 m. This makes using corrugated metallic water barriers problematic because of the higher hydrostatic pressure at deep sea, which may cause buckling of the corrugated metallic water barrier. Non-controllable changes to the original design of a metallic water barrier, such as by buckling, are undesirable, especially if the power cable is constantly moving, because the deformation may for instance cause stress concentrations reducing the fatigue life of the metallic water barrier.

### SUMMARY

In view of the above an object of the present disclosure is to provide a dynamic submarine power cable which solves or at least mitigates the problems of the prior art.

There is hence according to a first aspect of the present disclosure provided a dynamic submarine power cable comprising: a conductor, an insulation system arranged around the conductor, wherein the insulation system comprises an inner semiconducting layer arranged around the conductor, an insulation layer arranged around the inner semiconducting layer, and an outer semiconducting layer arranged around the insulation layer, and a metallic water blocking layer arranged around the insulation system, wherein the metallic water blocking layer is formed by a first section that is a corrugated metallic water blocking layer and a second section that is a smooth metallic water blocking layer.

The top section of a dynamic submarine power cable is the most fatigue-affected portion of the dynamic submarine power cable due to the wave motion in the surface region of the body of water in which the dynamic submarine power cable is installed. The corrugated metallic water blocking layer provides better fatigue resistance properties than a smooth metallic water blocking layer and the dynamic submarine power cable is beneficially installed such that the corrugated metallic water blocking layer extends along the top section of the dynamic submarine power cable. Further down in the water column, the dynamic submarine power cable is much less affected by wave motion but at larger depths the hydrostatic pressure could affect the shape of a corrugated metallic water blocking layer. Therefore, beneficially, the smooth metallic water blocking layer forms the bottom section of the dynamic submarine power cable to better withstand the ambient hydrostatic pressure without any deformation of the metallic water blocking layer at larger water depths.

The smooth metallic water blocking layer is non-corrugated.

According to one embodiment the first section is a top section, and the second section is a bottom section of the dynamic submarine power cable in an installed state.

According to one embodiment the corrugated metallic water blocking layer may extend from a first end, or within 10-15 metres from the first end, of the dynamic submarine power cable until it transitions to the smooth metallic water blocking layer, which extends from the transition point to a second end of the dynamic submarine power cable, opposite to the first end.

According to one embodiment the first section is at least 50 m long, such as at least 100 m long, such as at least 150 m long, such as at least 200 m long.

According to one embodiment the first section is at most 800 m long, such as at most 600 m long, such as at most 400 m long.

According to one embodiment the metallic water blocking layer is made in one length in a region where it transitions from being the corrugated metallic water blocking layer to being the smooth metallic water blocking layer.

According to one embodiment the insulation system is made in one length along the entire length of the dynamic submarine power cable. The dynamic submarine power cable may thus be without any factory joints along its entire length. A factory joint connects two semi-finished cable lengths, before any armour is applied, and involves restoration of the insulation system by means of vulcanisation. Typically, for factory joints, the conductors of the two semi-finished cable lengths are joined by welding.

One embodiment comprises a polymeric layer arranged around the metallic water blocking layer, wherein the polymeric layer extends along the first section and along the second section.

The polymeric layer may be dielectric or semiconductive.

One embodiment comprises an adhesive, wherein the adhesive is arranged between the polymeric layer and the smooth metallic water blocking layer in the second section to bond the polymeric layer to the metallic water blocking layer along the second section.

The adhesive may be dielectric if the polymeric layer is dielectric, or semiconductive if the polymeric layer is semiconductive.

According to one embodiment the metallic water blocking layer comprises one of copper, stainless steel, or aluminium.

The dynamic submarine power cable may be a medium voltage or a high voltage submarine power cable.

The dynamic submarine power cable may be an AC or a DC dynamic submarine power cable.

The dynamic submarine power cable may comprise one or more power cores, each power core comprising a conductor, an insulation system arranged around the conductor, wherein the insulation system comprises an inner semiconducting layer arranged around the conductor, an insulation layer arranged around the inner semiconducting layer, and an outer semiconducting layer arranged around the insulation layer, and a metallic water blocking layer arranged around the insulation system, wherein the metallic water blocking layer is formed by a first section that is a corrugated metallic water blocking layer and a second section that is a smooth metallic water blocking layer.

The dynamic submarine power cable may for example comprise, one, two, or three power cores.

There is according to a second aspect of the present disclosure provided an offshore structure comprising a floating platform, and a dynamic submarine power cable of the first aspect suspended from the floating platform, wherein the first section and the second section of the metallic water blocking layer are arranged in a water column between the floating platform and the seabed, wherein the first section forms a top section and the second section forms a bottom section of the dynamic submarine power cable in the water column.

Both the first section and the second section of the dynamic submarine power cable are thus in a suspended state, hanging from the floating platform, in the water column.

The dynamic submarine power cable may be jointed with a static submarine power cable laid on the seabed. The joint may be located on the seabed, and thus a portion of the second section of the dynamic submarine power cable may be laid on the seabed.

There is according to a third aspect of the present disclosure provided a method of producing a dynamic submarine power cable comprising a conductor, and an insulation system arranged around the conductor, wherein the insulation system comprises an inner semiconducting layer arranged around the conductor, an insulation layer arranged around the inner semiconducting layer, and an outer semiconducting layer arranged around the insulation layer, the method comprising: a) corrugating a metal tube arranged around an insulation system to form a corrugated metallic water blocking layer, which is a first section of a metallic water blocking layer of the dynamic submarine power cable, and b) performing a diameter reduction of a metal tube arranged around an insulation system to form a smooth metallic water blocking layer, which is a second section of the metallic water blocking layer, the first section and the second section together defining the axial length of the metallic water blocking layer.

According to one embodiment during steps a) and b) the dynamic submarine power cable is in one length, and the metal tube in step a) and the metal tube in step b) are the same, made in one length.

According to one embodiment the metal tubes in steps a) and b) are physically separate metal tubes, wherein the method comprises, after steps a) and b), c) jointing the first section and the second section.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows an example of a dynamic submarine power cable;

FIG. 2 schematically shows a side view of a portion of a metallic water blocking layer that transitions between being corrugated and smooth;

FIG. 3 schematically shows an offshore structure; and

FIG. 4 is a flowchart of a method of producing a dynamic submarine power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

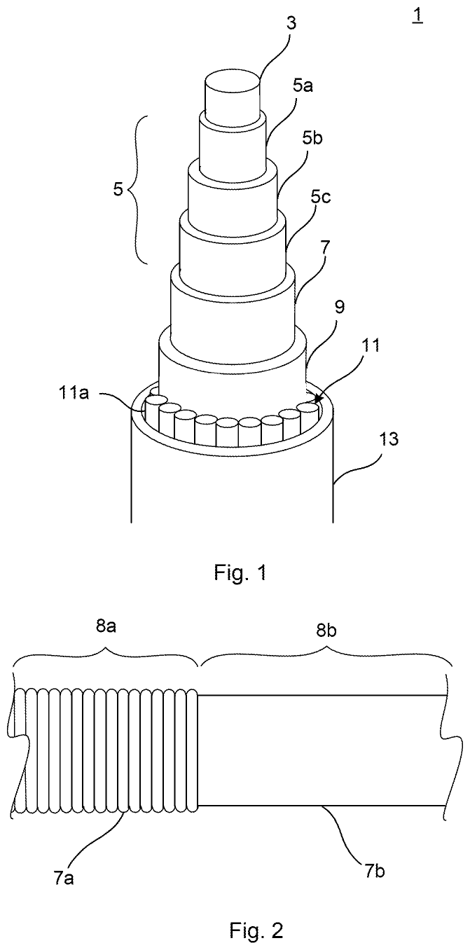

FIG. 1 shows an example of a dynamic submarine power cable 1. The dynamic submarine power cable 1 depicted in FIG. 1 has a single power core but could alternatively comprise more than one power core, such as two or three power cores.

The exemplified dynamic submarine power cable 1 comprises a conductor 3. The conductor 3 may typically comprise copper or aluminium.

The dynamic submarine power cable 1 comprises an insulation system 5. The insulation system 5 comprises an inner semiconducting layer 5a arranged around the conductor 3.

The insulation system 5 comprises an insulation layer 5b arranged radially outside the inner semiconducting layer 5a. Further, the insulation system 5 comprises an outer semiconducting layer 5c arranged radially outside the insulation layer 5b.

The insulation system 5 may for example be a triple extruded insulation system comprising polymeric material. Alternatively, the insulation system 5 may be formed of layers of oil impregnated paper, with the innermost and outermost layers being semiconducting paper layers.

The dynamic submarine power cable 1 comprises a metallic water blocking layer 7 extending along a majority of the length, or the entire length, of the dynamic submarine power cable 1. The metallic water blocking layer 7 may for example comprise copper and may in this case be pure copper or a copper alloy, or it may comprise aluminium and may in this case be pure aluminium or an aluminium alloy, or have a laminated structure, or it may comprise stainless steel.

The metallic water blocking layer 7 is arranged radially outside the insulation system 5.

The metallic water blocking layer 7 may be formed of a metal sheath folded around the insulation system 5, which is longitudinally welded during production of the dynamic submarine power cable 1.

The dynamic submarine power cable 1 may comprise a cushion layer arranged between the insulation system 5 and the metallic water blocking layer 7. The cushion layer may comprise a polymeric material. The cushion layer may be semiconductive.

The metallic water blocking layer 7 includes a first section that is corrugated and a second section that is smooth, i.e., non-corrugated. In particular, along the entire length of a first section the metallic water blocking layer 7 is a corrugated metallic water blocking layer, and along the entire length of a second section the metallic water blocking layer 7 is a smooth metallic water blocking layer. The first section transitions to the second section. Thus, the corrugated metallic water blocking layer transitions to the smooth metallic water blocking layer.

The corrugations of the corrugated metallic water blocking layer are formed in an axial direction of the dynamic submarine power cable 1. Hereto, the metallic water blocking layer 7 is undulating in the axial direction along the first section.

The dynamic submarine power cable 1 comprises a polymeric layer 9. The polymeric layer 9 is arranged around the metallic water blocking layer 7. The polymeric layer 9 extends along the first section and along the second section. The polymeric layer 9 may for example comprise a polyolefin such polyethylene or polypropylene, or polyvinylchloride.

The polymeric layer 9 may be in direct contact with the corrugated metallic water blocking layer.

The dynamic submarine power cable 1 may comprise an adhesive provided between the polymeric layer 9 and the metallic water blocking layer 7 to bond the polymeric layer 9 to the metallic water blocking layer 7 along the second section, i.e., where the metallic water blocking layer 7 is a smooth metallic water blocking layer.

The adhesive may for example comprise a polyolefin such as polyethylene.

The dynamic submarine power cable 1 may comprise one or more armour layers 11. Each armour layer 11 comprises a plurality of armour wires 11a. The armour wires 11a may be helically laid around the polymeric layer 9. The armour wires 11a may be metal armour wires, such as steel, e.g., galvanized steel or stainless steel, or copper wires, or they may be made of synthetic material such as a polymeric material, or some of the armour wires may be made of metal and others may be made of a synthetic material.

The dynamic submarine power cable 1 may comprise a bedding layer arranged between the polymeric layer 9 and the innermost layer of the one or more armour layers 11 in case the dynamic submarine power cable 1 comprises an armour layer 11. The bedding layer may be made of a polymeric material.

The dynamic submarine power cable 1 comprises an outer sheath or outer serving 13, forming an outermost layer of the dynamic submarine power cable 1. The outer sheath or outer serving 13 may comprise a polymeric material.

FIG. 2 shows a side view of a portion of the dynamic submarine power cable 1. In particular, the metallic water blocking layer 7 is shown with components external to the metallic water blocking layer 7 being removed for clarity.

FIG. 2 shows that the first section 8a, of which only a portion is shown, of the metallic water blocking layer 7 is the corrugated metallic water blocking layer 7a and that the second section 8b, of which only a portion is shown, is the smooth metallic water blocking layer 7b. The metallic water blocking layer 7 extends continuously along the entire length of the dynamic submarine power cable 1, and transitions between being corrugated and smooth.

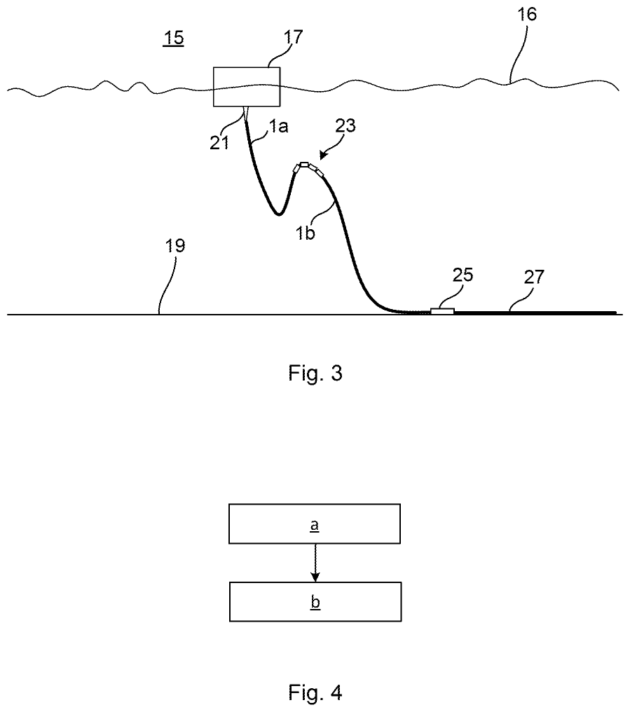

FIG. 3 shows an offshore structure 15 comprising a floating platform 17 that floats on water 16, and the dynamic submarine power cable 1.

The floating platform 17 may for example be the floating platform of a floating wind turbine, or a semi-submersible platform for oil and gas applications.

The dynamic submarine power cable 1 is suspended from the floating platform 17 and extends down to the seabed 19.

The offshore structure 15 comprises a bend stiffener 21, or alternatively a Bellmouth, connected to the floating platform 17, which is arranged around a top portion of the dynamic submarine power cable 1. In particular, the bend stiffener 21, or Bellmouth, is arranged around a top section 1a of the dynamic submarine power cable 1. The first section 8a of the metallic water blocking layer 7 is arranged along the top section 1a of the dynamic submarine power cable 1 as the dynamic submarine power cable 1 hangs from the floating platform 17 and extends to the seabed 19.

The first section 8a may be at least 50 m long, such as at least 100 m long, such as at least 150 m long, such as at least 200 m long. The first section 8a may be at most 800 m long, such as at most 600 m long, such as at most 400 m long.

The dynamic submarine power cable 1 may be provided with buoyance modules 23 to provide a wave configuration to the dynamic submarine power cable 1 as it extends towards the seabed 19. The dynamic submarine power cable 1 could alternatively be free hanging from the floating platform 17.

The dynamic submarine power cable 1 has a bottom section 1b which, like the first section 8a, is arranged hanging in the water column between the floating platform 17 and the seabed 19. The second section 8b is arranged along the bottom section 1b of the dynamic submarine power cable 1.

The second section 8b may according to one example be at least 100 m long, such as at least 200 m long. The second section 8b may according to one example be at most 3000 m or at most 5000 m long. Generally, the length of the second section 8b depends on the water depth.

A portion of the bottom section 1b and thus of the second section 8b extends to the seabed 19 and may extend along the seabed 19 to a joint 27 on the seabed 19, which connects the dynamic submarine power cable 1 to a static submarine power cable 27.

Turning now to FIG. 4, a method of producing a dynamic submarine power cable such as the dynamic submarine power cable 1 will be described.

In a first example, the first section 8a and the second section 8b is produced in one length. The insulation system 5 may be made in one length along the entire length of the dynamic submarine power cable 1. Thus, in this example, no factory joints which joint the insulation system 5 are made.

A metal tube is first arranged around the insulation system 5. The metal tube may be made by folding a metal sheath around the insulation system 5 and longitudinally welding, soldering, or gluing of the metal sheath.

In a second example, the first section 8a and the second section 8b are produced in two separate lengths and then jointed. In this case, the dynamic submarine power cable 1, or more typically, the one or more power cores of the submarine power cable 1, may typically also be produced in two lengths that are jointed.

In both examples, in a step a) the metal tube arranged around an insulation system 5 is corrugated to form the corrugated metallic water blocking layer 7a.

In step a) the first section 8a of the metallic water blocking layer 7 is produced.

Step a) is carried out by a corrugation machine through which at least that part or portion of the dynamic submarine power cable 1 for which the metal tube is corrugated passes.

In both examples, in a step b) a diameter reduction of the metal tube arranged around an insulation system 5 is performed to form the smooth metallic water blocking layer 7b.

Step b) is carried out by a roller assembly through which the second section 8b of the dynamic submarine power cable 1 passes.

In step b) the second section 8b of the metallic water blocking layer 7 is produced.

Step a) may be carried out before step b), or step b) may be carried out before step a). If the first section 8a and the second section 8b are physically separate lengths of the metallic water blocking layer 7 during steps a) and b), steps a) and b) may be carried out simultaneously in case the factory provides for such production possibilities.

In the first example, once steps a) and b) have been carried out, the corrugated metallic water blocking layer 7a and the smooth dynamic metallic water blocking layer 7b forms the metallic water blocking layer 7, which in this case may be made in one length in the region where it transitions from being corrugated to being smooth.

In the second example, the first section 8a and the second section 8b have to be jointed after steps a) and b) have been carried out. The jointing may involve jointing the conductor 3, the insulation system 5, and the corrugated metallic water blocking layer 7a and the smooth metallic water blocking layer 7b. The jointing of the corrugated metallic water blocking layer 7a and the smooth metallic water blocking layer 7b may for example be done by soldering or welding.

In one variation of the second example, only a portion of one of the metal tubes is corrugated. The remaining length of this metal tube may be made smooth by subjecting it to diameter reduction, and the smooth portion may be jointed with the smooth metallic water blocking layer 7b made in step b).

The inventive concept has mainly been described above with reference to a few examples. However, as is readily appreciated by a person skilled in the art, other embodiments than the ones disclosed above are equally possible within the scope of the inventive concept, as defined by the appended claims.

1. A dynamic submarine power cable comprising:
a conductor,
an insulation system arranged around the conductor,
wherein the insulation system includes an inner semiconducting layer arranged around the conductor, an insulation layer arranged around the inner semiconducting layer, and an outer semiconducting layer arranged around the insulation layer, and
a metallic water blocking layer arranged around the insulation system,
wherein the metallic water blocking layer is formed by a first section that is a corrugated metallic water blocking layer and a second section that is a smooth metallic water blocking layer.

2. The dynamic submarine power cable as claimed in claim 1, wherein the first section is a top section, and the second section is a bottom section of the dynamic submarine power cable in an installed state.

3. The dynamic submarine power cable as claimed in claim 1, wherein the corrugated metallic water blocking layer extend from a first end, or within 10-15 metres from the first end, of the dynamic submarine power cable until it transitions to the smooth metallic water blocking layer, which extends from the transition point to a second end of the dynamic submarine power cable, opposite to the first end.

4. The dynamic submarine power cable as claimed in claim 1, wherein the first section is at least 50 m long, such as at least 100 m long, such as at least 150 m long, such as at least 200 m long.

5. The dynamic submarine power cable as claimed in claim 1, wherein the first section, is at most 800 m long, such as at most 600 m long, such as at most 400 m long.

6. The dynamic submarine power cable as claimed in claim 1, wherein the metallic water blocking layer is made in one length in a region where it transitions from being the corrugated metallic water blocking layer to being the smooth metallic water blocking layer.

7. The dynamic submarine power cable as claimed in claim 1, wherein the insulation system, is made in one length along the entire length of the dynamic submarine power cable.

8. The dynamic submarine power cable as claimed in claim 1, comprising a polymeric layer arranged around the metallic water blocking layer, wherein the polymeric layer extends along the first section and along the second section.

9. The dynamic submarine power cable as claimed in claim 8, comprising an adhesive, wherein the adhesive is arranged between the polymeric layer and the smooth metallic water blocking layer in the second section to bond the polymeric layer to the metallic water blocking layer along the second section.

10. The dynamic submarine power cable as claimed in claim 1, wherein the metallic water blocking layer comprises one of copper, stainless steel, or aluminium.

11. The offshore structure comprising a floating platform, and a dynamic submarine power cable as claimed in claim 1 suspended from the floating platform, wherein the first section and the second section of the metallic water blocking layer are arranged in a water column between the floating platform and the seabed wherein the first section forms a top section, and the second section-kW forms a bottom section of the dynamic submarine power cable in the water column.

12. A method of producing a dynamic submarine power cable having a conductor, and an insulation system arranged around the conductor, wherein the insulation system includes an inner semiconducting layer arranged around the conductor, an insulation layer arranged around the inner semiconducting layer, and an outer semiconducting layer arranged around the insulation layer, the method comprising:
a) corrugating a metal tube arranged around an insulation system to form a corrugated metallic water blocking layer, which is a first section of a metallic water blocking layer of the dynamic submarine power cable, and
b) performing a diameter reduction of a metal tube arranged around an insulation system to form a smooth metallic water blocking layer, which is a second section of the metallic water blocking layer,
the first section and the second section together defining the axial length of the metallic water blocking layer.

13. The method as claimed in claim 12, wherein during steps a) and b) the dynamic submarine power cable is in one length, and the metal tube in step a) and the metal tube in step b) are the same, made in one length.

14. The method as claimed in claim 12, wherein the metal tubes in steps a) and b) are physically separate metal tubes, wherein the method comprises, after steps a) and b), c) jointing the first section and the second section.

15. The dynamic submarine power cable as claimed in claim 1, wherein the corrugated metallic water blocking layer extend from a first end, or within 10-15 metres from the first end, of the dynamic submarine power cable until it transitions to the smooth metallic water blocking layer, which extends from the transition point to a second end of the dynamic submarine power cable, opposite to the first end.

16. The dynamic submarine power cable as claimed in claim 2, wherein the first section is at least 50 m long, such as at least 100 m long, such as at least 150 m long, such as at least 200 m long.

17. The dynamic submarine power cable as claimed in claim 2, wherein the first section is at most 800 m long, such as at most 600 m long, such as at most 400 m long.

18. The dynamic submarine power cable as claimed in claim 2, wherein the metallic water blocking layer is made in one length in a region where it transitions from being the corrugated metallic water blocking layer to being the smooth metallic water blocking layer.

19. The dynamic submarine power cable as claimed in claim 2, wherein the insulation system is made in one length along the entire length of the dynamic submarine power cable.

20. The dynamic submarine power cable as claimed in claim 2, comprising a polymeric layer arranged around the metallic water blocking layer, wherein the polymeric layer extends along the first section and along the second section.
